(19) United States
(12) Patent Application Publication
(10) Pub. No.: US 2012/0196605 A1
(43) Pub. Date: Aug. 2, 2012

(54) Transfer of Sessions for Femtocells to Macro Mobile Networks

(75) Inventors: Ashish Nagpal, Bangalore (IN); Anish Sharma, Bangalore (IN)

(73) Assignee: Sonus Networks, Inc., Westford, MA (US)

(21) Appl. No.: 13/198,378

(22) Filed: Aug. 4, 2011

(30) Foreign Application Priority Data
Aug. 27, 2010 (IN) 2398/MUM/2010
Sep. 1, 2010 (IN) 2785/MUM/2010

(51) Int. Cl. H04W 36/14

(52) U.S. Cl. 455/444

(57) ABSTRACT

A method, server and computer program product is provided for transferring a session from a femtocell to a macromobile network. A request to transfer the session from the femtocell to a macromobile network is received. The request is translated into a format used by the macromobile network to receive session set-up requests and the translated request is provided to the macromobile network.

### CROSS REFERENCE TO RELATED APPLICATION

This application claims the benefit of and priority to India Provisional Patent Application No. 2398/MUM/2010, filed Aug. 27, 2010 and India Provisional Patent Application No. 2785/MUM/2010, filed Sep. 1, 2010, both of which are owned by the assignee of the instant application and the disclosures of which are incorporated herein by reference in their entireties.

### FIELD OF THE INVENTION

The invention relates generally to transferring voice sessions from a femtocell (e.g., Home Node B (HNB), 3GGP's term for a 3G femtocell) to a macromobile network (e.g., Universal Mobile Telecommunications System (UMTS) Terrestrial Radio Access Network (UTRAN) or Global System for Mobile Communication (GSM) Enhanced Data Rate for GSM evolution Radio Access Network (GERAN)).

### BACKGROUND OF THE INVENTION

A mobile subscriber can receive services (e.g., voice calls, text messaging, etc.) from femtocells and from macro networks, depending on the subscriber's location. In typical deployments by existing mobile network operators, services from femtocells are provided within a small geographic area. For example, femtocells can provide services within homes, building basements, and/or cafes. Macromobile networks can provide services outside of the geographical location covered by femtocells. Femtocell deplyoments can include a HNB and a HNB Gateway (HNB-GW). In most femtocell implementations, the HNB-GW is located outside of the femtocell coverage area. HNB-GWs can receive messages from multiple femtocells.

User equipment (UE) can communicate to a HNB system or a macromobile network (e.g., UTRAN or GERAN) via a Third Generation Partnership Protocol (3GPP) defined Uu interface as described in 3GPP TS 25.301. A HNB system can include a HNB, HNB Gateway (HNB-GW) and an IMS Centralized Services Interworking Function (ICS-IWF). A 3GPP defined Iuh protocol connects the components within a HNB system. The UE communicates with the HNB, which communicates with the HNB-GW.

When a network subscriber that has an active session (e.g., voice call) between a UE and a subscriber moves the UE out of the HNB coverage area, the active session can be transferred from being between the UE and the HNB to being between the UE and a macromobile network. The transfer is sometimes referred to as handover. During handover the HNB-GW or the ICS-IWF can interwork messages that are in a format used by the femtocell into a format used by a macromobile network (GERAN/UTRAN and/or IMS network).

When a core network is a MSC-based core network, the HNB-GW interworks the HNB messages into a format that is receivable by an MSC. When the core network is an IMS network, the ICS-IWF interworks the messages into a format that is receivable by an MSC server (e.g., into a E/NC protocol) and into a format that is receivable by an IMS network (e.g., into a SIP I2/I3 protocol).

A service provider's core network equipment (MSC and/or IMS Core) may not have the capability to perform handovers from Femtocells to the macro mobile network. Thus, it is desirable to allow for a femtocell session to be transferred to a macromobile network without communicating to a MSC server.

### SUMMARY OF THE INVENTION

A femtocell session can be transferred to a macromobile network without communicating to an MSC server by translating a request to transfer the femtocell session into a format used by the macromobile network to receive transfer request from a radio network controller (RNC). The femtocell appears to the RNC in the macromobile network as another RNC in the macromobile network. An advantage of the invention is that if a network provider does not have an MSC capable of performing handovers in their network, they can still perform handover of voice calls from femtocells.

In one aspect, the invention features a method of transferring a session that is in progress from a femtocell to a macromobile network. The method includes receiving, by a HomeNode B Gateway (HNB-GW) of the femtocell, a request to transfer the session from the femtocell to the macromobile network. The method also includes translating, by the HNB-GW of the femtocell, the request into a format used by the macromobile network to receive transfer requests from a RNC. The method also includes providing, by the HNB-GW of the femtocell, the request to the macromobile network.

In another aspect, the invention features a HomeNode B Gateway (HNB-GW) that includes a computing device configured transfer a session that is in progress from a femtocell to a macromobile network. The computing device is configured to receive a request to transfer the session from the femtocell to the macromobile network, translate the request into a format used by the macromobile network to receive transfer requests from a radio network controller (RNC), and provide the request to the macromobile network.

In another aspect, the invention features a server within a HomeNode B Gateway (HNB-GW) for transferring a session from a femtocell to a macromobile network. The server includes means for receiving a request to transfer the session from the femtocell to the macromobile network, means for translating the request into a format used by the macromobile network to receive transfer requests from a radio network controller (RNC), and means for providing the request to the macromobile network.

In some embodiments, any of the above aspects can include one or more of the following features. In some embodiments, the request is provided to a RNC of the macromobile network.

In some embodiments, translating the request involves interworking the femtocell's radio access network application part protocol (RANAP) within an Iuh protocol's request to transfer message into an Iur protocol's request to transfer message. In some embodiments, translating the request involves extracting parameters from an Iuh RANAP message. The RANAP message is part of a RANAP User Adaptation (RUA) message that is transmitted between the Home Node B (HNB) and the HNB-GW.

In some embodiments, providing the request to the macromobile network involves transmitting the extracted parameters via an Iur protocol. In some embodiments, the method also involves receiving, by the HNB-GW of the femtocell, a release request from the macromobile network to release the session from the femtocell, and interworking, by the HNB-GW of the femtocell, the release request into a format used by a user equipment of the femtocell to receive release requests from the HNB-GW of the femtocell.

In some embodiments, interworking the request involves interworking the macromobile network's Iur protocol's request to release message into an Iuh protocol's request to release the message.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary HNB system, according to the Third Generation Partnership Project (3GPP) protocol 3GPP TS 25.467.

FIG. 2 is a block diagram of an exemplary HNB system, according to 3GPP TR 23.832.

FIG. 3 is a block diagram of an exemplary HNB system, according to an illustrative embodiment of the invention.

FIG. 4 is a block diagram of an exemplary HNB system, according to an illustrative embodiment of the invention.

FIG. 5 is an exemplary sequence diagram showing transferring of a session from being between a femtocell to a macromobile network, according to an illustrative embodiment of the invention.

### DETAILED DESCRIPTION

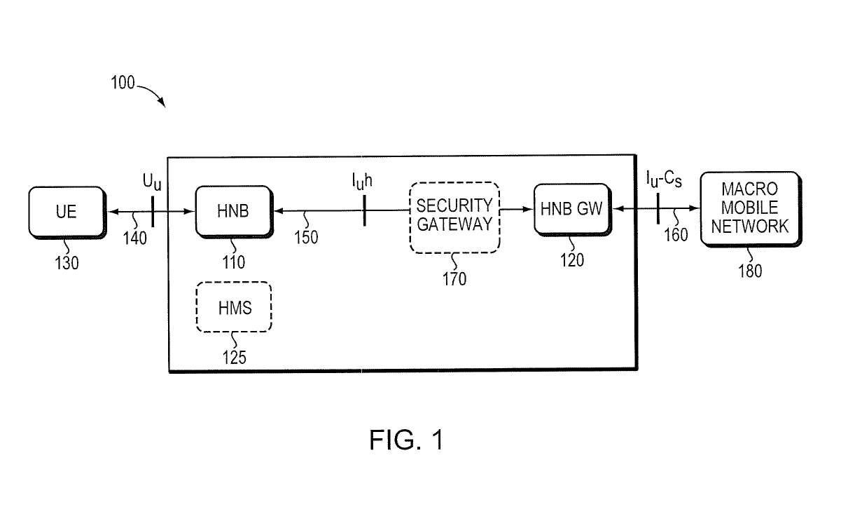

FIG. 1 is a block diagram 100 of an exemplary HNB system 105, according to the 3GPP protocol 3GPP TS 25.467. The HNB system 105 includes a HNB 110, a HNB-GW 120, and a

HNB Management System (HMS) 125. The HNB 110 can connect to an existing residential broadband service to provide 3G radio coverage for UE's within the HNB system 105 coverage area. The HNB-GW 120 can connect the HNB 110 to a macromobile network 180.

In operation, a UE 130 establishes a session by transmitting and receiving Uu protocol message(s) 140 with the HNB 110. The HNB 110 transmits and recieves Iuh protocol message(s) 150 with the HNB-GW 120. The HNB-GW 110 interworks the Iuh protocol message(s) 150 into Iu-cs protocol message(s) 160 so that the HNB 110 can communicate with a MSC of a macromobile network 180. In some embodiments, the macromobile network includes a GERAN. In some embodiments, the macromobile network includes a UTRAN. In some embodiments, the Iuh protocol message(s) 150 are transmitted through a security gateway 170. In some embodiments, the HNB 110 and the HNB-GW 120 are co-located. It is easily understandable by one of ordinary skill that 3GPP offers many configurations of HNB system architecture as part of the 3GPP standard, and that the configurations described herein are for exemplary purposes only.

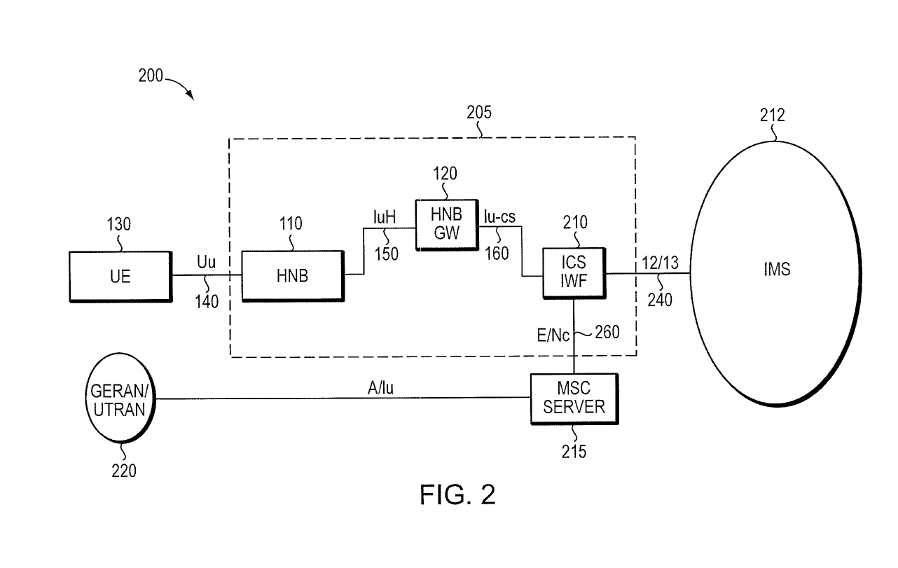

FIG. 2 is a logical block diagram 200 of an exemplary HNB system 205, according to 3GPP TR 23.832. The HNB system 205 includes the HNB 110, the HNB-GW 120 and an ICS-IWF 210. The HNB system 202 can communicate with an IMS network 212 and/or an MSC server 215.

The UE 130 establishes a session with the HNB system 205 by transmitting and receiving Uu protocol message(s) 140 with the HNB 110. The HNB 110 transmits and receives Iuh protocol message(s) 150 with the HNB-GW 120. The HNB-GW 120 interworks the Iuh protocol message(s) 150 into Iu-cs protocol message(s) 160 (and vice versa) to transmit and receive Iu-cs messages with the ICS-IWF 210.

The ICS-IWF 210 interworks Iu-cs protocol message(s) 160 into two types of messages (and vice versa): 1) IMS SIP I2 and/or I3 protocol message(s) 240 to set up, terminate and provide services with the IMS network 212; and 2) E/NC protocol message(s) 260 to transfer the session to a GERAN 220 such that the ICS-IWF 210 appears as a MSC server to the MSC server 215. In some embodiments, the GERAN 220 is replaced with a UTRAN.

It will be easily recognizable to one of ordinary skill that 3GPP TR 23.832 describes that the HNB system 205 can transfer a femtocell session to a GSM network that does not require communication with the IMS network 212. In these embodiments, for example, the HNB-GW 120 can interwork the Iuh protocol message(s) 150 into Iu-cs protocol message(s) 160 to communicate with a MSC server that is in communication with a GERAN.

In general, in the various embodiments of the invention discussed below, an existing UE session transfers from a femtocell to a macromobile network by interworking messages from a protocol (i.e. interface) used by the femtocell into a protocol that a Radio Network Controller (RNC) uses to communicate as part of the macromobile network.

A HNB-GW and/or an ICS-IWF can interface with a RNC of a macromobile network by appearing as just another RNC in the macromobile network. In this manner, the macromobile network's MSC server can be excluded from the transfer or handover procedure. The component that performs the interworking of HNB-GW output into a format that appears to a RNC of the macromobile network to be a RNC can be termed as an interworking RNC (I-RNC). The macromobile network can be an IMS network and/or an MSC based network.

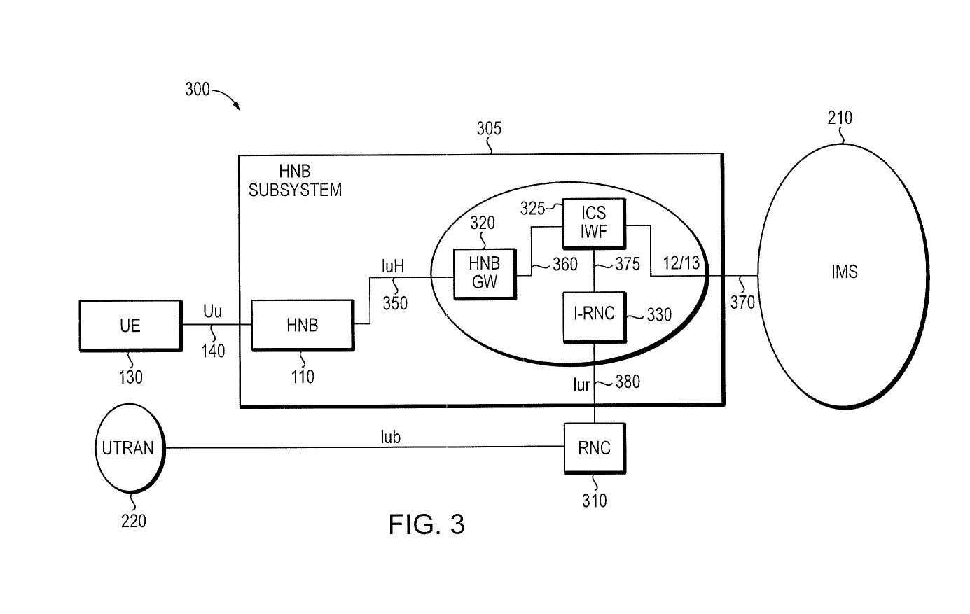

FIG. 3 is a block diagram 300 of an exemplary HNB system 305, according to an illustrative embodiment of the invention. The HNB system 305 includes a HNB 315, the HNB-GW 320, the ICS-IWF 325, and an interworking RNC Function (I-RNC) 330. The HNB system 305 can communicate with the IMS network 210 and/or a RNC 310.

The UE 130 establishes a session by transmitting and receiving Uu protocol message(s) 140 with the HNB 110. The HNB 110 transmits and receives Iuh protocol message(s) 350 with the HNB-GW 320. The HNB-GW 320 interworks the Iuh protocol message(s) 350 into Iu-cs protocol message(s) 360 (and vice versa) to transmit and receive Iu-cs messages with the ICS-IWF 325.

The ICS-IWF 325 interworks Iu-cs protocol message(s) 360 (and vice versa) an IMS SIP I2 and I3 protocol message(s) 370 to set up, terminate and provide services with the IMS network. The I-RNC 330 interworks Iuh messages 350, that include handover information, from the HNB 110 into Iur protocol message(s) 380 (and vice versa) such that the I-RNC 330 appears as a RNC to a RNC 310. Interworking the Iuh message(s) 350 into Iur protocol message(s) 380 can allow for the HNB system 305 to transfer the session between the UE 130 and the HNB 110 to the UE 130 and the GERAN 220 without sending messages to a MSC server.

The Iuh protocol message(s) 350 used to communicate messages between the HNB 110 and the HNB-GW 320 contain a number of protocols as defined in 3GPP TS 25,467. One of the protocols is a Radio Access Network Application Part User Adaptation (RUA). The RUA protocol carries a RANAP protocol. The RANAP protocol can be used to carry signaling between a RNC and a MSC in a macromobile network. In some embodiments, the I-RNC 330 interworks the Iuh message(s) 350 into Iur protocol message(s) 380 by extracting the RANAP details from the Iuh protocol message(s) 350. In some embodiments, the I-RNC 330 interworks the Iuh message(s) 350 into any proprietary interface for the purpose of call continuity across the HNB 110 and the macromobile network, irrespective of whether the HNB 110 is connected to a UMTS network or IMS network.

In various embodiments, the Iur protocol message(s) 380 are used for both hard and soft handovers as defined in the 3GPP TR 25.931. The HNB-GW 110 can use the hard handovers procedures applicable and interwork them with RANAP handover procedures to achieve the desired handover. Both Internet Protocol (IP) and Asynchronous Transfer Mode (ATM) transport options can be used by an I-RNC for interworking into Iur protocol messages as specified by the 3GPP protocols.

In some embodiments, the I-RNC 330 appears as a serving RNC (S-RNC) to the RNC 340. In these embodiments, the RNC 310 can operate as a standard Drift RNC (D-RNC). A 3GPP defined Iur protocol connects any two RNCs in a micro mobile network. The Iur protocol 3GPP standard is 3GPP TS 25.423.

In some embodiments, the GERAN 220 is replaced by a UTRAN. In various embodiments, the HNB 110, the HNB-GGW 320, the ICS-IWF 325 and the I-RNC 330 are a single logical element or are divided in any combination into two or more logical elements. In various embodiments, the HNB 110, the HNB-GGW 320, the ICS-IWF 325 and the I-RNC 330 are implemented on a single computing device or implemented in any combination on two or more computing devices.

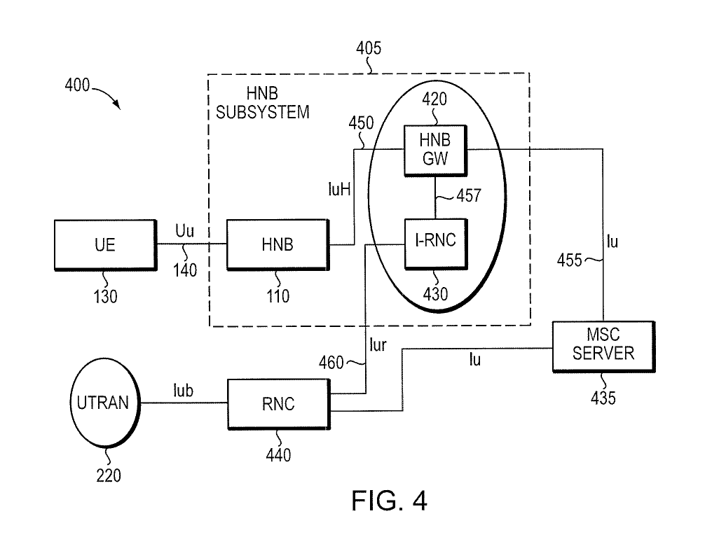

FIG. 4 is a block diagram 400 of an exemplary HNB system 405, according to an illustrative embodiment of the invention. The HNB system 405 includes the HNB 110, the HNB-GW 420, and I-RNC 430. The HNB system 305 can communicate with a GMSC server 435 in a GSM core network and with a RNC 440 in the macromobile network.

The UE 130 establishes a session by transmitting and receiving Uu protocol message(s) 140 with the HNB 110. The HNB 110 transmits and receives Iuh protocol message(s) 450 with the HNB-GW 420.

The HNB-GW 420 interworks the Iuh protocol message(s) 450 (and vice versa) into Iu protocol message(s) 455 to transmit and receive set up, terminate and service Iu protocol messages with the MSC server 435.

The I-RNC 430 interworks the Iuh protocol message(s) 450 (and vice versa) into Iur protocol message(s) 460 such that the I-RNC 405 appears as a RNC to a RNC 340 during transfer. Interworking the Iuh protocol message(s) 450 into Iur protocol message(s) 460 can allow for the HNB system 405 to transfer the session between the UE 130 and the HNB 110 to the UE 130 and the GERAN 220.

In some embodiments, the I-RNC 430 interworks the Iuh protocol message(s) 450 into Iur protocol message(s) 460 by extracting the RANAP details from the Iuh protocol message(s) 450. In some embodiments, the I-RNC 430 interworks the Iuh protocol message(s) 450 into any proprietary interface for the purpose of session continuity across the HNB 110 and the macromobile network, irrespective of whether the HNB 110 is connected to a UTRAN/GERAN and/or IMS network.

In some embodiments, the I-RNC 430 appears as a S-RNC to the RNC 440. In these embodiments, the RNC 440 can operate as a D-RNC.

In some embodiments, the GERAN 220 is replaced by a UTRAN. In various embodiments, the HNB 110, the HNB-GGW 420, and the I-RNC 430 are a single logical element or are divided in any combination into two or more logical elements. In various embodiments, the HNB 110, the HNB-GGW 420, and the I-RNC 430 are implemented on a single computing device or implemented in any combination on two or more computing devices.

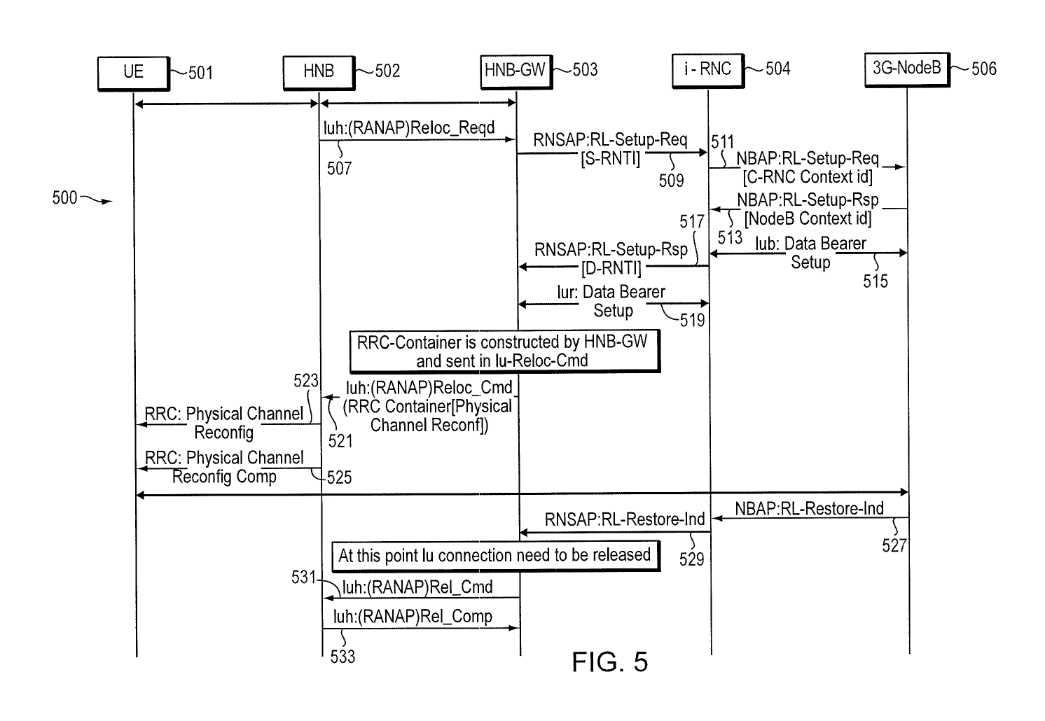

FIG. 5 is an exemplary sequence diagram showing transferring of a session from being between a femtocell to a macromobile network, according to an illustrative embodiment of the invention.

The HNB 502 sends an Iuh protocol relocation required request 507 that includes RANAP details to HNB-GW 503. The Iuh protocol relocation required request 507 RANAP details can include an information element (IE) of a Source RNC to Target RNC Transparent Container that includes a RRC container IE as described in 3GPP TS 25.413. The RRC container IE can include S-RNC relocation information that describes a physical channel and a transport channel information used by the UE 501 as described in 3GPP TS 25.331.

The HNB-GW 503 can interwork the Iuh protocol relocation required request 507 into an Iur protocol radio link set up request 509 such that the HNB-GW appears to be a S-RNC to D-RNC 504. In this embodiment, the HNB-GW 503 includes an I-RNC (e.g., I-RNC 330 as described above in FIG. 3). It will be easily understood by one of ordinary skill in the art that the I-RNC can be logically implemented and/or physically implemented as separate from the HNB-GW 503.

The radio link set up request 509 can be populated based on the following: 1) RANAP information received in the Iuh protocol relocation required request 507 and/or 2) default values predefined by the operator. In some embodiments, if the HNB-GW 503 determines the handover is only for voice bearers then Multimedia Broadcast Multicast Service (MBMS) bearer service information and/or extended dynamic host configuration protocol (EDHCP) channels or Fractional Dedicated Physical Channel (F-DPCH) information can be excluded from the Iur protocol message radio link set up request 509. In some embodiments, the HNB-GW 503 indicates to the D-RNC 504 to apply the transmit diversity combination locally. In some embodiments, the HNB-GW 503 stores a context for this interworking procedure. The stored context can include the RRC container state and integrity and/or ciphering related parameters.

The D-RNC 504 sends a radio link request message 511 to a Node-B 506 of the macromobile network according to 3GPP protocols. The Node-B 506 transmits a radio link response message 513 and an Iub protocol data bearer setup message 515 to the D-RNC 504. The D-RNC 504 transmits an Iuh protocol relocation setup response 517. If the transport used is Asynchronous Transfer Mode (ATM) the D-RNC can send an Iur protocol data bearer setup message 519 to the HNB-GW 503.

The HNB-GW 502 sends a Iuh protocol relocation command 521 that includes an RRC container IE to the HNB 502. The RRC container IE can be interworked by the HNB-GW 502 based on the Iuh protocol relocation setup response 517 and/or stored content. In various embodiments, the Iuh protocol relocation command 521 can include one or more of:
1. An Target RNC to Source RNC Container IE that can include a RRC Container IE. The RRC container IE can include a Physical Channel Reconfiguration RRC message. The IEs can be interworked by the HNB-GW 503.
2. An Physical Channel Reconfiguration message that can facilitate a change of radio bearers by the UE to the target cell. The Physical Channel Reconfiguration's IE's can be generated based on information received in the radio link response message 513. The generated IE's can include but are not limited to: 1) Maximum UL TX power, 2) UL DPCH Info, 3) Primary CPICH info, and/or 4) Downlink Info for RL. In some embodiments, instead of generating a “Physical Channel Configuration” message, any other RRC container IE can be generated which allows the UE to transfer to the macromobile network.
3. Once the physical channel reconfiguration is complete, the UE's radio link with HNB 502 can be lost. If the UE 501 losses its radio link, the HNB 502 can send an Iurelease-Request message to the HNB-GW 503 that indicates the cause of the release as a failure of radio link. The Iu resources cleanup can be performed by the HNB-GW 503.

The HNB 502 sends a Uu protocol physical channel reconfiguration command 523 that includes the RRC container of the Iuh protocol relocation command 521 to UE 501. The UE 501 sends a Uu protocol physical channel reconfiguration complete 525 to the HNB 502. At this point in the messaging sequence, the session is transferred to being between the UE 501 and Node-B 506.

The Node-B 506 sends a radio link restore indication message 527 to the D-RNC 504. The D-RNC 504 sends a radio link restore indication message 529 to the HNB-GW 503. Upon receipt of the radio link restore indication message 529 the HNB-GW 503 determines that the session between the UE 501 and the Node-B 506 is active and the HNB-GW 503 sends a release request to the HNB 502. The HNB 502 sends a release complete to the HNB-GW 503.

In some embodiments, the HNB-GW 503 can assume full S-RNC functionality and interwork mid call service messages between the UE 501 and the macromobile network subsequent to a handoff.

In some embodiments, if the macromobile network is an IMS network and a user of the IMS network releases the session subsequent to a handoff then the HNB-GW 503 can interwork a SIP:BYE received by the IMS network into a Iur protocol downlink signal transfer release request to the Node-B 506. The Node-B 506 transmits a release to the UE 501 according to 3GPP protocol standards. The D-RNC 504 transmits the release to the HNB-GW 503. The HNB-GW 503 behaves as a S-RNC to the D-RNC 503 according to 3GPP protocol standards. In some embodiments, if the macromobile network is an UTRAN or GERAN and a user of the UTRAN or GERAN releases the session, then the HNB-GW 503 can interwork a direct transfer received by UTRAN or GERAN into a Iur protocol downlink signal transfer release request to the Node-B 506. The Node-B 506 transmits a release to the UE 501 according to 3GPP protocol standards. The D-RNC 504 transmits the release to the HNB-GW 503. The HNB-GW 503 behaves as a S-RNC to the D-RNC 503 according to 3GPP protocol standards.

In some embodiments, if the macromobile network is an IMS network and the UE 501 releases the session, the HNB-GW 503 can interwork a release request received by the HNB 502 from the D-RNC 503 into a SIP:BYE message to the IMS network. The HNB-GW 503 interworks a 200 OK response received from the IMS network into a release complete towards the D-RNC 503 according to 3GPP protocol standards. The HNB-GW 503 behaves as a S-RNC to the D-RNC 503 according to 3GPP protocol standards.

In some embodiments, if the macromobile network is an UTRAN or GERAN and the UE 501 releases the session, the HNB-GW 503 can interwork a release request received by the HNB 502 from the D-RNC 503 into a Iu protocol direct transfer towards a MSC server. The HNB-GW 503 interworks a Iu protocol direct transfer release complete response received from the MSC server into a release complete towards the D-RNC 503 according to 3GPP protocol standards. The HNB-GW 503 behaves as a S-RNC to the D-RNC 503 according to 3GPP protocol standards.

In some embodiments, if an operator's policy is to provide services through the macromobile network then the HNB-GW 503 can de-register the UE 501 from the macromobile network by transmitting messages to the macromobile network according to 3GPP protocol standards. In some embodiments, the operator's policy is configured on the HNB-GW 503.

Although a flow for a voice call session is shown above, data sessions can be transferred from HNB to UTRAN as well. In some embodiments, when the session is a data session a serving General Packet Radio Service Support Node A (SGPRS) can replace an MSC server of the GSM and the Iu-PS protocol according to 3GPP standards can be applicable between serving GPRS support node (SGSN) and HNB-GW.

The above described techniques can be implemented in a variety of ways. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described techniques can be implemented by Packet-based networks and/or Circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Transmitting devices can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art can appreciate the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of transferring a session that is in progress from a femtocell to a macromobile network, comprising:
receiving, by a HomeNode B Gateway (HNB-GW) of the femtocell, a request to transfer the session from the femtocell to the macromobile network;
translating, by the HNB-GW of the femtocell, the request into a format used by the macromobile network to receive transfer requests from a radio network controller (RNC); and
providing, by the HNB-GW of the femtocell, the request to the macromobile network.

2. The method of claim 1 wherein the request is provided to a RNC of the macromobile network.

3. The method of claim 1 wherein translating the request further comprises:
interworking the femtocell's radio access network application part protocol within an Iuh protocol's request to transfer message into an Iur protocol's request to transfer message.

4. The method of claim 3 wherein translating the request further comprises extracting parameters from an Iuh Radio Access Network Application Part (RANAP) message, the RANAP message is part of a RANAP User Adaptation (RUA) message that is transmitted between the Home Node B (HNB) and the HNB-GW.

5. The method of claim 4 wherein providing the request to the macromobile network further comprises transmitting the extracted parameters via an Iur protocol.

6. The method of claim 1 further comprising:
receiving, by the HNB-GW of the femtocell, a release request from the macromobile network to release the session from the femtocell; and
interworking, by the HNB-GW of the femtocell, the release request into a format used by a user equipment of the femtocell to receive release requests from the HNB-GW of the femtocell.

7. The method of claim 6, wherein interworking the request further comprises:
interworking the macromobile network's Iur protocol's request to release message into an Iuh protocol's request to release the message.

8. A HomeNode B Gateway (HNB-GW) comprising a computing device configured to transfer a session that is in progress from a femtocell to a macromobile network, the computing device further configured to:
receive a request to transfer the session from the femtocell to the macromobile network;
translate the request into a format used by the macromobile network to receive transfer requests from a radio network controller (RNC); and
provide the request to the macromobile network.

9. The computing device of claim 8 wherein the request is provided to a RNC of the macromobile network.

10. The computing device of claim 9 wherein translating the request further comprises:
interworking the femtocell's radio access network application part protocol within an Iuh protocol's request to transfer message into an Iur protocol's request to transfer message.

11. The computing device of claim 10 wherein translating the request further comprises extracting parameters from an Iuh Radio Access Network Application Part (RANAP) message, the RANAP message is part of a RANAP User Adaptation (RUA) message that is transmitted between the Home Node B (HNB) and the HNB-GW.

12. The computing device of claim 11 wherein providing the request to the macromobile network further comprises transmitting the extracted parameters via an Iur protocol.

13. The computing device of claim 8 further configured to:
receive a release request from the macromobile network to release the session from the femtocell; and
interwork the release request into a format used by a user equipment of the femtocell to receive release requests from the HNB-GW of the femtocell.

14. The computing device of claim 13 wherein interworking the request further comprises:
interworking the macromobile network's Iur protocol's request to release message into an Iuh protocol's request to release message.

15. A server within a HomeNode B Gateway (HNB-GW) for transferring a session from a femtocell to a macromobile network, the server comprising:
means for receiving a request to transfer the session from the femtocell to the macromobile network;
means for translating the request into a format used by the macromobile network to receive transfer requests from a radio network controller (RNC); and
means for providing the request to the macromobile network.

16. The server of claim 15 wherein the request is provided to a RNC of the macromobile network.

17. The server of claim 15 wherein translating the request further comprises:
interworking the femtocell's radio access network application part protocol within an Iuh protocol's request to transfer message into an Iur protocol's request to transfer message.

18. The server of claim 17 wherein translating the request further comprises extracting parameters from an Iuh Radio Access Network Application Part (RANAP) message, the RANAP message is part of a RANAP User Adaptation (RUA) message that is transmitted between the Home Node B (HNB) and the HNB-GW.

19. The server of claim 15 further comprising:
means for receiving a release request from the macromobile network to release the session from the femtocell; and
means for interworking the release request into a format used by a user equipment of the femtocell to receive release requests from the HNB-GW of the femtocell.

20. The server of claim 19, wherein interworking the request further comprises:
interworking the macromobile network's Iur protocol's request to release message into an Iuh protocol's request to release message.
